(19) United States
(12) Patent Application Publication
(10) Pub. No.: US 2011/0274897 A1
(43) Pub. Date: Nov. 10, 2011

(54) COMPOSITE COMPONENT HAVING A COVER LAYER

(75) Inventors: Willy Dauner, Leonberg (DE); Frank Hoecker, Dornstadt (DE)

(73) Assignee: DAIMLER AG, Stuttgart (DE)

(21) Appl. No.: 13/144,717

(22) PCT Filed: Jan. 19, 2010
(86) PCT No.: PCT/EP10/00284

§ 371 Date: Jul. 15, 2011

(30) Foreign Application Priority Data
Jan. 26, 2009 (DE) 10 2009 006 130.4

(51) Int. Cl. B32B 3/00

(52) U.S. Cl. 428/203; 428/209; 428/195.1

(57) ABSTRACT

The invention relates to a composite component of at least (3) different material layers, having the following layer composition: a) a carrier layer or carrier structure of metal and/or fiber-reinforced plastic, b) a bonding agent layer of elastomer, c) a cover layer of carbon fiber-reinforced or mixed carbon fiber-reinforced plastic, wherein the plastic and the arrangement of the carbon fibers or mixed carbon fibers are chosen such that the carbon fibers or mixed carbon fibers are optically visible on the surface of the cover layer.

The invention relates to a composite component made of at least 3 different material layers according to the preamble of the claim, a planar component in vehicles, particularly as doors, flaps or roofs, of metal sheet and/or fiber-reinforced plastic with a cover layer according to the preamble of claim 14 and an advantageous method for producing this composite component or planar component according to the preamble of claim 18.

Composite components of different material layers are used as lightweight composite materials in different technical usage areas, as with aerospace, ship or motor veicle construction. The composite components are thereby often used as planar components in the body construction.

In order to provide composite components which fulfill high mechanical requirements, fiber-reinforced, particularly carbon fiber-reinforced plastics (CFK) are often used as one of the material layers. With the usual lightweight composite materials of this type, the material layer of CFK thereby takes up the essential load-carrying part of the composite component.

An important target of this mixing construction is always thereby to limit the part of CFK as much as possible due to costs.

These lightweight composite components are preferably used as thin planar components of motor vehicles, such as automotive doors, roof parts, trunk lids or engine hoods. The CFK material layer is thereby usually on the bottom or inner side, thus facing away from view. If the CFK material layer is on the viewing side, particularly on the outside or on the top, it is usually concealed by a cover layer, cover film or cover varnish, so that it does not appear optically.

It can however also be desired that the structure of the CF material appears optically due to design purposes. As fiber-reinforced materials are known as high performance materials, the optical emergence of the CFK material can support a high quality appearance of a composite component. With motor vehicles, or automobiles, the same high demands are made of the surfacte quality of the CFK material as of the other automobile surfaces, particularly varnish coatings. These high quality demands are known as class A viewing surface.

The production of lightweight composite parts with decorative cover layers of CFK material usually takes place by the preforming of the cover layer as a thin CFK component or CFK plate and the subsequent adhering onto the planar component. This procedure is elaborate, particularly hardly suitable for geometrically more discerning (planar) components. In this connection, the curved surface of a vehicle door can already be seen to be geometrically discerning.

There also exist approaches to apply the CFK material onto the substrate in the form of prepregs, or the like, and to cure these then on the substrate. Problematic are thereby in particular the reduction coinciding with the curing of the CFK material and the inadequate thermal expansion coefficients. Substrates with large surfaces can distort thereby and the CFK surface can receive rejections and unevenness, which result in an unacceptable quality for viewing uses.

From WO 99/50057 is known a three-layer stiffening material, which is composed of two polymer layers and a stiffening layer. The polymer layer facing the substrate to be stiffened can thereby be a foam layer, while the outer layer arranged on the resilient foam layer is a layer of a hard foam. The third layer can be a glass fiber layer for effecting the stiffening.

From EP 1 556 213 B1 is known a multi-layer laminate for stiffening planar substrates, containing at least two thermally curable binder means layers and two layers of fiber-containing textile planar formations. A binder means layer facing the substrate to be stiffened, a binder means layer turned away from the substrate to be stiffened, a layer od a fiber-containing planar formation arranged between these binder means layers and a second layer of a fiber-containing textile planar formation arranged on the binder means layer turned away from the substrate to be stiffened is used thereby. The binder means layer facing the substrate to be stiffened is connected to the substrate to be stiffened in an adhering manner in the cured state and has the same or a lower E module than the second binder means layer (14).

It is the object of the invention to provide a cost-efficient lightweight composite component with a high quality material appearance, particularly a planar component for motor vehicles, such as doors, flaps or roofs of metal sheet and/or fiber-reinforced plastic and to show a suitable cost-efficient production method for this.

The object is solved by a composite component of at least 3 different material layers, with the following layer composition:

a) a carrier layer or a carrier structure of metal and/or fiber-reinforced plastic

b) a bonding agent layer of elastomer,

c) a cover layer of carbon fiber-reinforced or mixed carbon fiber-reinforced plastic,

wherein the plastic and the arrangement of the carbon fibers or mixed carbon fibers are chosen such that the carbon fibers or mixed carbon fibers are optically visible on the surface of the cover layer, with the characteristics of claim 1.

A further solution of the object is given by a planar component for motor vehicles, of metal sheel and/or fiber-reinforced plastic, which carries a cover layer of carbon fiber-reinforced plastic, which is connected via an elastomer intermediate layer, wherein the carbon fibers of the cover layer emerge in an optically recognizable manner with the characteristics of claim 14.

The solution of the object according to the method is given by a method for producing a composite component or planar component according to the characteristics of claim 18.

According to the invention, a composite component of at least 3 different material layers is provided in a first design. The following layer construction is chosen thereby:

a) a carrier layer or a carrier structure of metal or fiber-reinforced plastic

b) a bonding agent layer made of elastomer

c) a cover layer made of carbon fiber-reinforced or mixed carbon fiber-reinforced plastic.

For the optical and decorative properties of the component it is essential that the plastic and the fiber arrangement of the carbon fiber- or mixed carbon fiber-reinforcement (called (mixed) carbon fiber reinforcement in summary) are chosen in such a manner that the carbon fibers or mixed carbon fibers are optically visible at the surface of the cover layer. This means for the plastic in particular that it is transparent or translucent and that it is also not present in the cover layer in an unusually high part. On the other hand, the optically visible arrangement of the (mixed) carbon fibers at the surface is not meant that the fibers emerge from the surface. The cover layer rather has a smooth surface, which is terminated by an at least thin plastic or resin layer. The quality of the cover layer is particularly of a class A viewing surface.

For forming a smooth and high quality cover layer, a particular importance is given to the intermediate layer of elastomer. In the composite component, it has the function of a bonding agent layer between the different materials. In the material composite, it adheres the usually incompatible materials of the substrate and the cover layer and compensates thermal tensions between these different materials. This is particularly important if the cover layer or the substrate are formed of resins, which have a reaction reduction during the production.

In a preferred design, the cover layer is hard, scratch-resistant and weather-resistant. For this, one can refer back to suitable resin compositions. This design is particularly advantageous for uses as doors, flaps or roofs in motor vehicles.

In a particularly preferred manner, a cover layer is used, which can be used untreated on its surface. Alternatively, it is however also possible to apply a coating, for example a clear varnish.

In a preferred design of the invention, the carrier layer or the carrier structure is constructed of metal. With planar components for motor vehicles, it can typically be the usual motor vehicle or automobile metal sheets. The metal of the carrier layer or of the carrier structure is preferably constructed of steel and/or aluminum alloy. Metal composite designs are also comprised hereby. In this version, a considerable part of the load-bearing function is accorded to the metal or the metal sheet. The thickness of the automobile sheet can however be reduced slightly compared to the comparable uses.

In a further design of the invention, the carrier layer or the carrier structure (also called substrate in the following) is constructed of fiber-reinforced palstic, particularly of carbon, aramide, and/or glass fiber-reinforced plastic. In this version, the presence of the bonding agent layer also has a clearly positive influence on the quality and the durability of the surface quality of the cover layer.

In a further design of the invention, the carrier layer or the carrier structure is of fiber-reinforced plastic resin according to the SMC (SheetMouldingCompound), BMC (BulkMoldingCompound) or RTM (ResiTransferMolding) method. The decorative function of the cover layer is particularly in the foreground here. On the one hand, the substrate materials themselves are comparatively rigid and less need an additional reinforcement by the cover layer, and, on the other hand, the surfaces of the materials produced according to the methods mentioned above are not suitable for the viewing region of motor vehicle bodies in a qualitative manner. They usually fulfill the requirements of class A surfaces not without refinishing.

As a further design of the substrate, mixing designs of metals and fiber-reinforced plastics are also conceivable.

For the connection of the cover layer to the substrate, the bonding agent layer is important. According to the invention, the bonding agent layer is formed of an elastomer layer. This does not have to be formed in a material-unitary manner. This layer can thus for example also carry an adhesive layer on one side or both sides. The adhesive layer changes the layer properties of the elastomer layer in the manner that an optimum connection to the respective material surface of metal, plastic or (mixed) carbon fiber-reinforced resin takes place. The elastomer can itself also be formed by an adhesive, which has elastomer properties after the curing. The elastomer is ptreferably formed of caoutchouc, silicon caoutchouc or rubber. Suitable caoutchoucs are amongst others polybutadiene caoutchouc (BR), styrol butadiene caoutchouc (SBR), nitrile caoutchouc (NBR), oligomeric siloxanes or cyclic dimethyl polysiloxanes (SI) and acrylate caoutchouc (ACM).

Particularly in connection with the production technique of the composite component via the hot pressing, thermoplastic elastomers (TPE) are also well suited, as they can be processed pastically under heat exposure and subsequent cooling. Copolyesters, polyether block amides or styrol block copolymers are suitable TPEs amongst others.

The thickness of the elastomer layer typically has the same size as the one of the cover layer. The elastomer layer is preferably however considerably thinner than the cover layer.

The cover layer is formed by carbon fiber- or mixed carbon fiber-reinforced plastic according to the invention. The fibers are thereby present as fiber bundles or yarn in the usual processing form.

In addition to the plastics purely reinforced by carbon fibers, mixed forms of carbon fibers and other reinforcement fibers can be used (corresponding to mixed carbon fiber-reinforced plastic). As many of the further reiforcement fibers are colored differently to the carbon fiber, the optical overall impression of the cover layer can hereby be varied within large limits by the choice of the mixture ratio, the mixing or individualization into common or separate fiber bundles, or by their geometric arrangement (e.g. wave or web pattern, etc.).

The fiber reinforcement thus comprises a mixture of carbon fibers and further reinforcement fibers, preferably aramide fibers, glass fibers, metal fibers, polymer fibers or natural fibers, particularly hemp fibers, flax fibers, cellulose fibers or cotton fibers, wherein all fiber types can be arranged next to each other as individual fiber strands or also mixed in a fiber strand. Particularly preferred mixtures consist of carbon fibers and aramide fibers.

The fiber reinforcement or the geometric arrangement of the fibers is formed by fabrics, knitted fabrics or knotted fabrics. A regular arrangement of the fibers is a particularly preferred design. Particularly, optically recognizable patterns or regularities shall hereby be formed at the cover layer surface.

In a further design, the fibers are arranged in a disordered manner. Hereby, one has to place value on the choice of the fibers, the fiber content and the method guidance again with regard to the optical impression of the surface. Particularly with a high part of natural fibers, disordered layers of the fibers can lead to extraordinary optics.

The fiber part in the cover layer have the part usual for CFK.

Duroplastic plastics are mainly consideed as plastics of the cover layer, as are known from the technology of the CFK processing. The thermoplasts such as polycarbonate and PMMA and elastomers are for example suitable as further plastics.

The thickness of the cover layer can be reduced insofar that the load-carrying or reinforcing function of the cover layer only has a subordinated meaning. Usually, a few fiber bundles or yarn layers, for example 2, preferably 3 to 10, are sufficient in order to bring about the optical effect. The thickness of the substrate is then a multiple above the one of the cover layer.

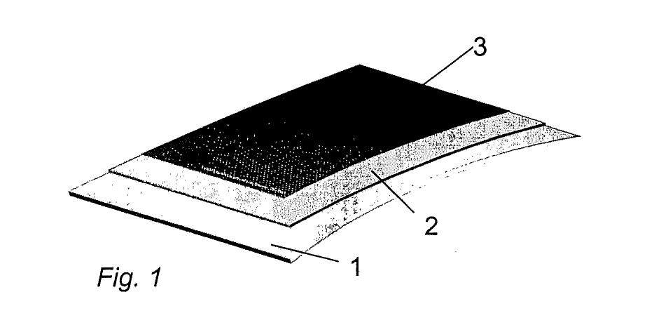

FIG. 1 shows the schematic depiction of a planar composite component, with a carrier layer (1), a bonding agent layer of elastomer (2) and a cover layer (3). The thickness ratios shown in the FIGURE correspond to a preferred design of the invention.

It can be advantageous to provide or to seal the cover layer with a transparent or translucent varnish layer. This is particularly advantageous if the composite component is used as a planar component in motor vehicles.

The composite component can further also be arranged in the interior region of a vehicle body, so that the cover layer can be seen from the interior of the vehicle. In addition to planar or sheet-shaped geometries, geometries formed as columns or rods are also important thereby. The composite component can here for example be used as an A B or C pillar of a passenger motor vehicle.

The construction of the composite component is however not restricted to 3 layers. A layered material compound can thus for example be used again as the substrate. In a preferred design, the individual layers are represented in a multiple manner with a mylti-layer construction, wherein at least one elastomer layer is arranged between each carrier layer and cover layer. A typical design of this arrangement is a carrier layer of two metal sheets connected via an elastomer layer, followed by an elastomer and a cover layer. A further typical design of this arrangement is a carrier layer of two SMC plates connected via an elastomer layer followed by an elastomer and a cover layer. A further typical design of this arrangement is a carrier layer of metal sheet, an elastomer layer and a cover layer followed by an elastomer and a cover layer.

A further solution of the object according to the invention is found in a planar component in motor vehicles, particularly doors, flaps or roofs of a metal sheet and/or fiber-reinforced plastic, which carries a cover layer of carbon fiber-reinforced plastic (CFK), which is connected via an elastomer intermediate layer, wherein the carbon fibers of the cover layer emerge as optically recognizable.

The cover layer is preferably coated with a transparent or translucent varnish. The cover layer is particularly coated with the body cover varnish of the motor vehicle.

In a preferred design of the invention, the planar component is designed in such a manner that the cover layer only contributes in a subordinated part to the load-bearing function of the entire planar component. The thickness of the cover layer is hereby preferably chosen smaller than the thickness of the substrate and is below 50% of the entire planar component.

A further aspect of the invention is a particularly suitable production method of the designed composite component of at least three different material layers or the designed planar component in motor vehcles, particularly doors, flaps, or roofs, of metal sheet and/or fiber-reiforced plastic.

It is thereby essential for the method that the individual layers are connected to the composite or planar component in a common process. It is provided that the joining of all individual layers of substrate, elastomer layer and cover layer takes place in a common pressing process.

The carrier layer or the substrate, the elastomer material and plastically deformable material are first introducted into a press mold for this.

The CFK material is meant to be the raw material of (mixed) carbon fiber reinforcement and plastic that can still be deformed plastically. Resins are particularly used as plastic, which can be cured cold or thermally in the mold. Typical CFK material are fabrics, knitten fabrics or knotted fabrics or also prepegs impregnated with reaction resin.

The elastomer material can be an elastomer that is already cross-linked, particularly with an adhesive coating. This can virtually be processed like thin films, or be introduced into the press.

The elastomer can also be plastically deformable or weakly cross-linked elastomer material. The cross-linking is carried out cold or warm during pressing, if necessary.

The mold is then closed and the CFK material and possibly elastomer or adhesive coatings are cured under pressure, respectively cross-linked.

The advantage of the method is that the end product can be produced in a single method step and that more complex geometries can also be reproduced without problems. The elastomer which is still soft during the pressing and the plastic CFK material can adapt ideally to the topography of the substrate and compensate unintended irregularities or roughnesses.

The reaction reduction of the CFK material occurring during the pressing method is substantially absorbed by the elastomer layer. By means of the following of the mold halves in the press, the smooth surface of the curing cover layer can be maintained.

1-23. (canceled)

24. A composite component of at least 3 different material layers, with the following layer composition
a) a carrier layer or carrier structure of metal and/or fiber-reinforced plastic,
b) a bonding agent layer of elastomer,
c) a cover layer of carbon fiber-reinforced or mixed carbon fiber-reinforced plastic,
wherein the plastic and the arrangement of the carbon fibers or mixed carbon fibers are chosen such that the carbon fibers or mixed carbon fibers are optically visible on the surface of the cover layer, wherein a regular arrangement of the fibers in the form of optically recognizable patterns or regularities is present at the cover layer surface and the thickness of the cover layer is reduced to such an extent that it contributes to the load-carrying function of the entire planar component only as a subordinated part.

25. The composite component according to claim 24, wherein the metal of the carrier layer or carrier structure is steel and/or aluminum alloy.

26. The composite component according to claim 24, wherein the fiber-reinforced plastic of the carrier layer or carrier structure is carbon-, aramide- and/or glass fiber-reinforced plastic resin.

27. The composite component according to claim 26, wherein the carrier layer or the carrier structure is formed of fiber-reinforced plastic resin according to the SMC, BMC or RTM method.

28. The composite component according to claim 24, wherein the bonding agent layer is formed of elastomer, which has an adhesive layer on one or both sides.

29. The composite component according to claim 24, wherein the elastomer is formed by an adhesive.

30. The composite component according to claim 24, wherein the elastomer is formed of India rubber, silicon rubber or rubber.

31. The composite component according to claim 24, wherein the mixed carbon fiber reinforcement is formed of a mixture of carbon fibers and aramide fibers, glass fibers, cellulose, natural fibers and/or cotton fibers, wherein all fiber types are arranged as individual strands next to each other or mixed in a fiber strand.

32. The composite component according to claim 24, wherein the fiber reinforcement is formed of a fabric, a knitted fabric, or a knotted fabric of carbon fibers or mixed carbon fibers.

33. The composite component according to claim 24, wherein the individual layers occur in the composite component in a multiple manner, wherein an elastomer layer is arranged at least between each carrier layer and cover layer.

34. The composite component according to claim 33, wherein at least one of the carrier layers has the same construction as the cover layer.

35. The composite component according to claim 24, wherein the carrier layer is formed in the shape of a sheet or the carrier structure is formed in the shape of a column or a rod.

36. A planar component in motor vehicles, of metal sheet and/or fiber-reinforced plastic, wherein it carries a cover layer of carbon fiber-reinforced plastic, which is connected via an elastomer intermediate layer,
wherein the carbon fibers of the cover layer emerge in an optically recognizable manner, and
wherein a regular arrangement of the fibers in the form of optically recognizable patterns or regularities is present on the cover layer surface and the thickness of the cover layer is reduced to such an extent that it contributes to the load-carrying function of the entire planar component only as a subordinated part.

37. The planar component according to claim 36, wherein the cover layer is sealed with a transparent or translucent varnish layer.

38. The planar component according to claim 36, wherein the planar component is a door, a flap or a roof.
